(19) United States
(12) Patent Application Publication
(10) Pub. No.: US 2014/0095695 A1
(43) Pub. Date: Apr. 3, 2014

(54) CLOUD AWARE COMPUTING DISTRIBUTION TO IMPROVE PERFORMANCE AND ENERGY FOR MOBILE DEVICES

(71) Applicants: Ren Wang, Portland, OR (US); Alexander W. Min, Hillsboro, OR (US); Jr-Shian (James) Tsai, Beaverton, OR (US); Mesut Ergin, Portland, OR (US); Tsung-Yuan C. Tai, Portland, OR (US)

(72) Inventors: Ren Wang, Portland, OR (US); Alexander W. Min, Hillsboro, OR (US); Jr-Shian (James) Tsai, Beaverton, OR (US); Mesut Ergin, Portland, OR (US); Tsung-Yuan C. Tai, Portland, OR (US)

(21) Appl. No.: 13/631,415

(22) Filed: Sep. 28, 2012

(51) Int. Cl. G06F 15/173

(52) U.S. Cl. 709/224

(57) ABSTRACT

An intelligent cloud aware computing distribution architecture for a device. A network conditions monitor is to observe and identify decision impact factors of tasks in a runtime environment. A dynamic profiler, coupled to the network conditions monitor, is to receive runtime information regarding the decision impact factors identified by the network conditions monitor and produce a profile based on the decision impact factors. Runtime offload decision making logic is to process the profile produced by the dynamic profiler based on the received decision impact factors according a predetermined policy and to determine final offloading decisions based on the predetermined policy and the processed decision impact factors. The runtime offload decision making logic is to provide the final offloading decisions to the applications on the device for executing the tasks locally or remotely based on the determined final offloading decision.

### BACKGROUND

With the fast development of mobile devices equipped with high-speed network access, e.g., smartphones and tablets, mobile users enjoy an unprecedented, rich user experience with an increasing number of applications. Examples of such experiences include gaming, video creation, personal health management, audio capture and processing, etc. However, the mobile user experience is still limited, compared with higher end desktop and laptops, due to the following factors, among others: hardware limitation in terms of CPU (central processing unit) computation power and memory capacity, limited battery life, and potentially high communication cost.

With the fast development of cloud computing and high speed wireless technologies, it has become feasible to offload computing to the cloud infrastructure servers, e.g., remote cloud servers such as Amazon EC2® (elastic computer cloud) or local cloud servers such as nearby desktops. Recent research has proposed implementation approaches to offload certain mobile applications to remote servers. For example, the offloading inference engine (OLIE) makes intelligent offloading decisions. OLIE proposes a dynamic offloading engine to overcome the memory resources constraints of local malle devices. In “MAUI: Making Smartphones Last Longer with Code Offload”, Eduardo Cuervo, et. al. (2010), code execution is offloaded using Microsoft .NET Common Language Runtime (CLR) to remote servers to reduce energy consumption. However, progress is needed in the area of making optimal decisions based on comprehensive runtime dynamic information.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a graph showing the growth of processor speed and memory size over the last 15 years;

FIG. 2 illustrates a high level overview of an intelligent cloud aware computing distribution architecture according to an embodiment;

FIG. 3 shows measured throughput over Wi-Fi™ and 3G in different locations according to an embodiment;

FIG. 4 shows the energy cost comparison based on different channel conditions according to an embodiment;

FIG. 5 shows a flowchart of the policy engine process for making offloading decisions according to an embodiment; and

FIG. 6 illustrates a block diagram of an example machine according to an embodiment upon which any one or more of the techniques (e.g., methodologies) discussed herein may be performed.

### DETAILED DESCRIPTION

Smartphones or tablets with network access and multiple sensors that run various applications are becoming more and more popular. Many applications that provide rich user experiences demand high computing capabilities, e.g., fast processor speed and large memory size, and remain power-hungry, which negatively impacts battery life.

Embodiments provide optimized performance, energy, user experience and cost through cloud aware computing distribution by systematically evaluating the dynamic situations or conditions, e.g., devices, servers, and network conditions, and by making optimal decision on the computing distribution between local devices and remote servers. By making decisions based on the systematic evaluations of the dynamic conditions, an optimal mobile user experience may be achieved by taking advantage of the rapidly developed and widely available cloud computing technologies.

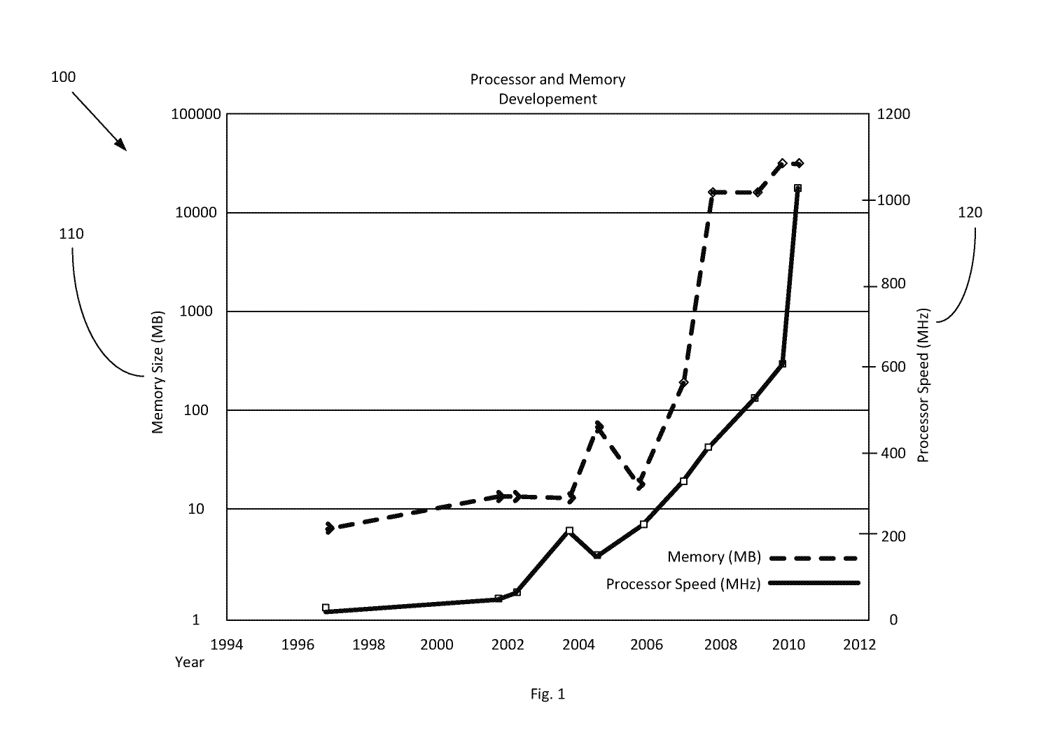

FIG. 1 is a graph 100 showing the growth of processor speed and memory size over the last 15 years. In FIG. 1, memory size 110 has plateaued relative to increases in processor speed 120. Although the hardware specification increases very fast, many applications still use more resources than mobile devices, such as smartphones and tablets, may provide. Further, such applications may not suffer from the resource problem when they are running on commercial server or desktop which has much higher CPU processing power and larger memory. Remote servers and desktop/laptops resources are relatively abundant and easy to access.

The increase in cloud computing, high end processors and platforms, and high speed wireless technologies further drive efforts offload processing to more powerful computing platforms. It is natural to take advantage of the trend and offload certain computing task from small mobile devices to backend cloud servers to improve the performance and energy.

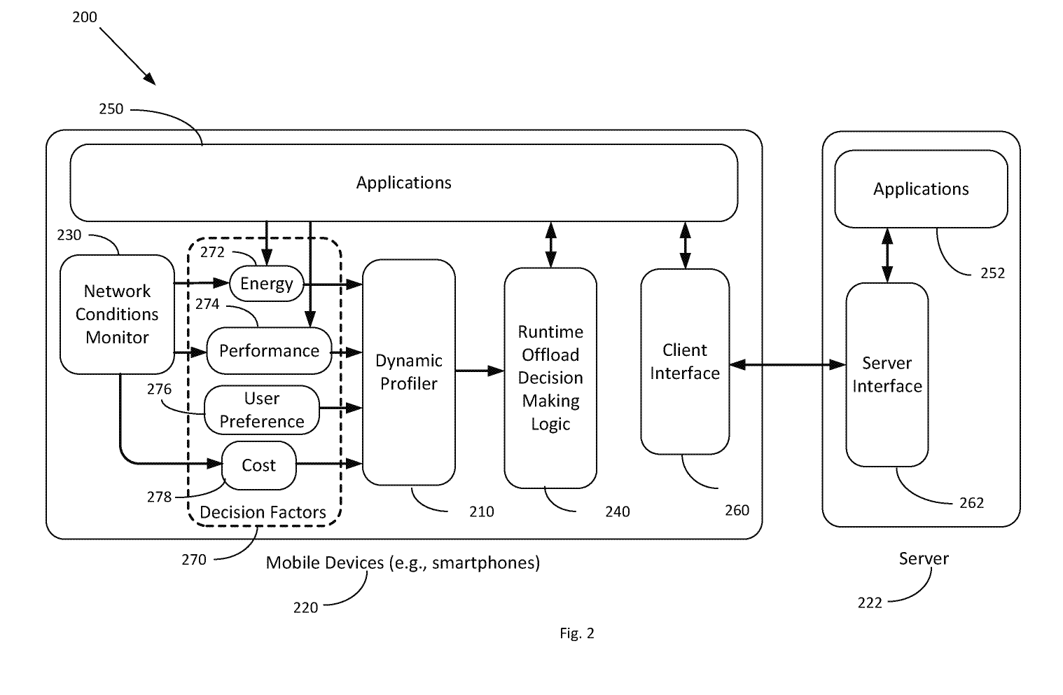

FIG. 2 illustrates a high level overview of an intelligent cloud aware computing distribution architecture 200 according to an embodiment. With intelligent computing distribution between local devices and cloud servers, mobile end users may enjoy, among other things, improved performance and extended battery life. On the mobile device 220 in FIG. 2, a dynamic profiler 210 continuously collects run time information which is used to determine the cost and benefit of executing tasks at the remote server 222 and to make the offloading decision. The network conditions monitor 230 observers the network availability and channel conditions that change vastly over the time. This information includes energy saving benefit (communication cost vs. computation saving); potential performance improvement for running at a faster server; user preference, e.g., some users may prefer local execution for security considerations; and the monetary cost of execution remotely, e.g., the data plan cost for uploading and downloading execution related data. FIG. 2 will be discussed in further detail below.

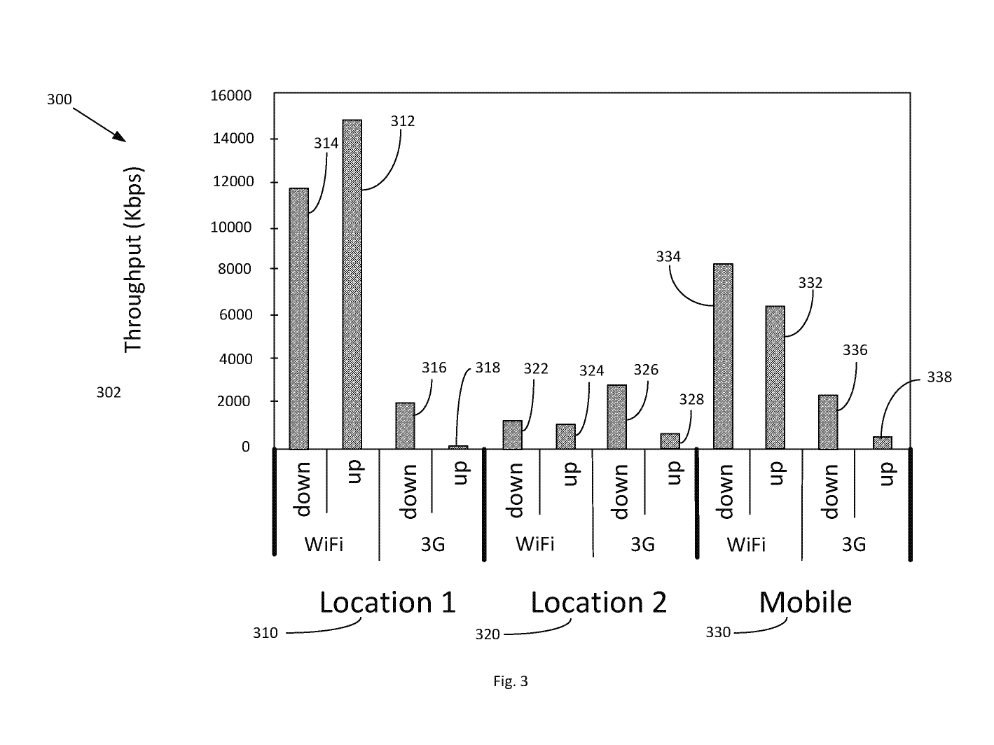

FIG. 3 shows measured throughput over Wi-Fi™ and 3G in different locations 300 according to an embodiment. The measured throughput of Wi-Fi™ and 3G at different locations indicates various channel condition and large variations. This large variation impacts the energy, performance and the cost significantly. In FIG. 3, location 1 (310), location 2 (320) and mobile device 330 are considered. The throughput 302 is highest for the Wi-Fi™ upstream 312 and Wi-Fi™ downstream 314 of location 1 (310) and the Wi-Fi™ upstream 332 and Wi-Fi™ downstream 334 for the mobile device 330 are the highest. The next three highest throughputs 302 are the 3G downstream 316 for location 1 310, the 3G downstream 326 for location 2 320 and the 3G downstream 336 for the mobile device 330. The throughputs 302 for the 3G upstream 318 for location 1 310, the 3G upstream 328 for location 2 320 and the 3G upstream 338 for the mobile device 330, as well as the Wi-Film downstream 322 and the Wi-Firm upstream 324 for location 2 320 are very low.

Referring again to FIG. 2, once the dynamic profiler 210 collects information and the policy engine/runtime offload decision making logic 240 makes a final offloading decision, the applications 250, 252 on mobile device 220 and remote server 222, respectively, work together with the client interface 260 and the server interface 262, to carry out the offloading action, if any by moving the execution from the local device to the remote server. The remote server 220 may be a backend remote cloud server or a local cloud server such as desktops nearby. The implementation of the execution offloading may use one many of existing offloading mechanisms, e.g., OLIE. However, the intelligent cloud aware computing distribution architecture 200 according to an embodiment continuously monitors and collects comprehensive information and makes optimal offloading decision based on multiple considerations.

The network conditions monitor 230 identifies many decision impact factors 270. In FIG. 2, four important factors that may influence the final offloading decision are shown: energy 272, performance 274, user preference 276 and cost 278. The runtime offload decision making logic 240 may consider all or a subset of the decision impact factors 270 depending on policies that may be predetermined. The offload decision making logic 240 may be customized to weight each factor differently, based on a desired effect.

Regarding energy 272, consumption by communication is vastly different with different network interface and channel conditions. Measurement and literature studies show that there is a potential 10× energy difference between Wi-Fi and 3G interfaces for data transmission. Even with the same interface, e.g., Wi-Fi, the energy for transmitting the same amount of data shows up to 5× difference due to different channel conditions.

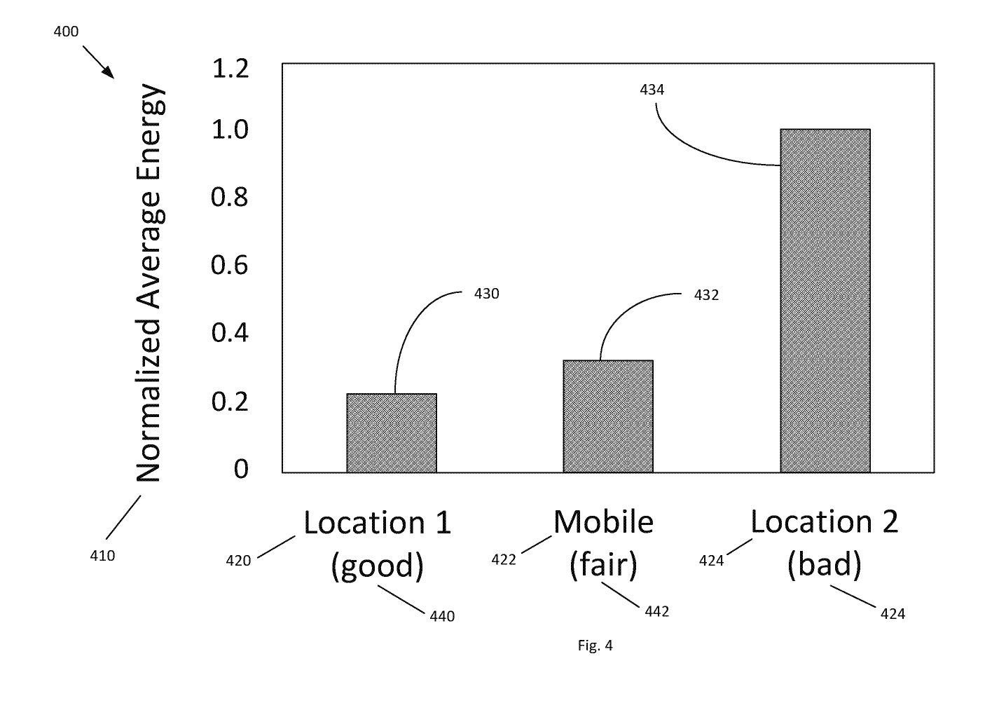

FIG. 4 shows the energy cost comparison 400 based on different channel conditions according to an embodiment. In FIG. 4, the normalized average energy 410 for location 1 (420), the mobile device 422 and location 2 (424) is determined. The normalized average energy 430 for location 1 (420) is low, which is good 440. The normalized average energy 432 for the mobile device 422 is a little higher, which is fair 442. The normalized average energy 434 for location 2 (424) is much higher, which is bad 444.

Thus, the total energy impact by offloading may be determined using a comparison of the local resource saved by offloading the computing task versus the additional communication energy caused by uploading to/downloading the offloading related data from the remote servers.

Referring to FIG. 2 again, performance 274 may be improved by offloading tasks from the mobile device that the remote server may execute much faster. Performance gain depends on the following factors: network conditions which determine the communication time, the remote server capability which determines the potential speedup, an application characteristics which determine how much the extra hardware capability may speed up the execution.

User preference 276 may influence where the job is executed. Different users may want to execute the job locally or remotely. For example, a user may want a certain application to be always executed at the local mobile device 220, or in-country server, e.g., server 777, for security reasons.

Monetary Costs 278 are also considered when making an offloading decision. For example, if only a 3G interface is available and the user is about to exceed the data plan limit, the cost of offloading will be much higher than the case when free Wi-Fi™ is available.

The dynamic profiler 210 collects the raw information, i.e., the decision impact factors 270, and converts them to corresponding parameters that may be used as input for the runtime offload decision making logic. Energy gain factor E is calculated as E=E_{compute}−E_{comm}. E_{compute} is the energy saved by offloading, and E_{comm} is the extra energy consumed for communication, considering network condition and amount of data need to be moved. Performance gain factor P is calculated as P=P_{compute}−P_{comm}. P_{compute} is the performance speed up by running the application in a faster server; and P_{comm} is the performance loss, e.g., extra time is used for communication. User preference, U, is gathered from user. Cost, C, is calculated by considering the network interface and server usage cost (if relevant), and calculate the monetary cost. For example, if free Wi-Fi™ is available and the server usage is free, then C=0.

The runtime offload decision making logic 240 implements the policy engine that takes the runtime information and makes a final offloading decision. Details of the policies are described herein below. It is worth noting that although in FIG. 2 the runtime offload decision making logic 240 is located in the device, it could be also located at the remote server 222 to save device computation energy.

The client interface 260 and the server interface 262 is to provide processing of data communicated between mobile device 220 and server 222 to enable offloading the execution of tasks from the mobile device 220. Once a decision being made, if it an offloading decision, the applications 250, 252 work with the client interface 260 and the server interface 262 to offload the computing to the cloud. Server 222 includes at least one application for support the offloading of computing from the mobile device. Many solutions are available for the implementation of the interface, e.g., client/server proxies.

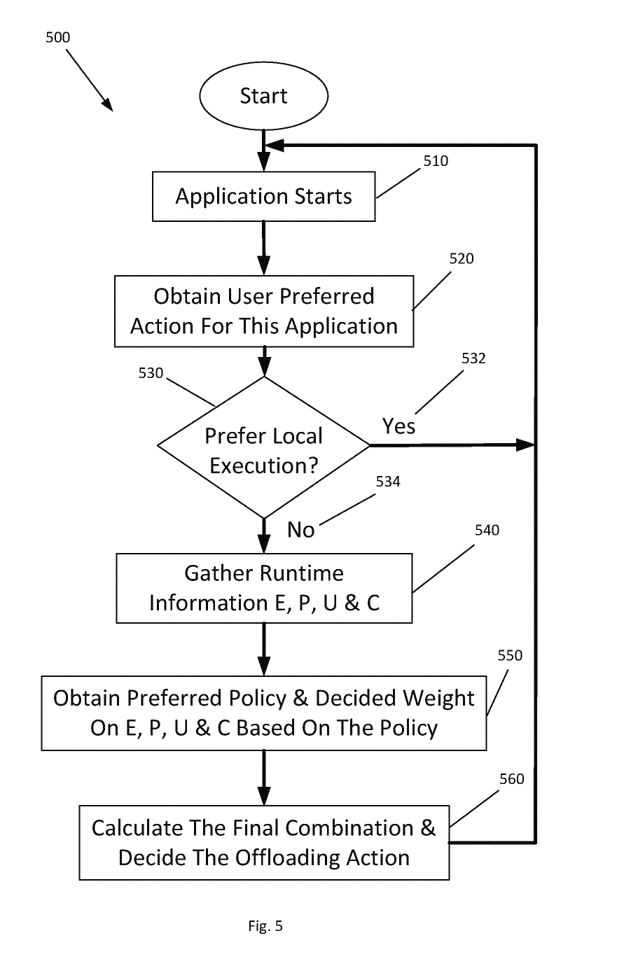

FIG. 5 shows a flowchart 500 of the policy engine process for making offloading decisions according to an embodiment. In FIG. 5, an application starts 510. The action for this application that is preferred by the user is obtained 520. A decision is made whether the user prefers local execution 530. If yes 532, the process is executed locally and the process returns to the start. If not 534, runtime information F, P, U and C are gathered 540. The preferred policy and the decided weight on E, P, U & C based on the preferred policy is obtained 550. Then, the final combination is calculated and the offloading decision is made 560.

However, those skilled in the art will recognize that there may be multiple policies that may be applied to determine the final offloading action. For example, a power saving policy only considers energy saving or gives more weight to energy saving aspect; in other words, it may give more weight to energy factor E. A performance policy puts more emphasis on the performance improvement. A cost effective policy: This policy puts more emphasis on the cost of offloading. With a balanced policy, the decision making logic tries to balance energy, performance and cost factors.

Accordingly, many applications may potentially benefit from the intelligent cloud aware computing distribution including image processing, such as facial and object recognition, audio processing including speech and audio content recognition and security including taint analysis and virus scans.

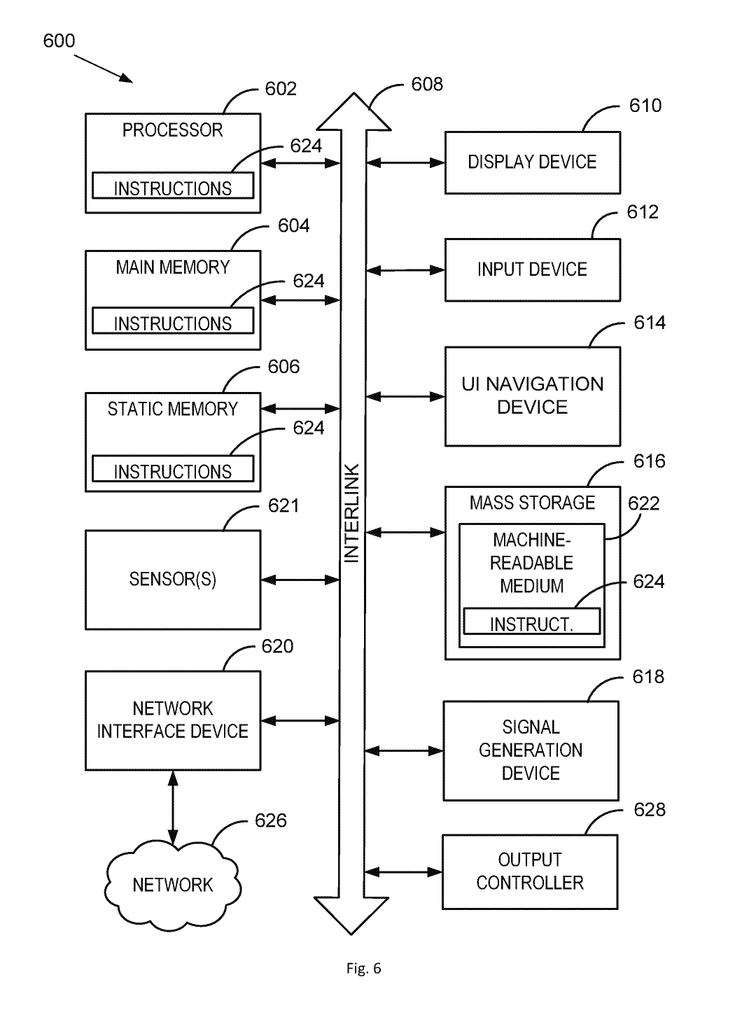

FIG. 6 illustrates a block diagram of an example machine 600 according to an embodiment upon which any one or more of the techniques (e.g., methodologies) discussed herein may perform. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 611 (e.g., a mouse). In an example, the display unit 610, input device 617 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), or other wired or wireless (e.g., infrared (IR)) connection to communicate or control one or more peripheral devices (e.g., a printer, card reader, etc.).

The storage device 616 may include at least one machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, and/or associated caches and servers) that configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having resting mass. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks ((e.g., channel access methods including Code Division Multiple Access (CDMA), Time-division multiple access (TDMA), Frequency-division multiple access (FDMA), and Orthogonal Frequency Division Multiple Access (OFDMA) and cellular networks such as Global System for Mobile Communications (GSM), Universal Mobile Telecommunications System (UMTS), CDMA 2000 1x* standards and Long Term Evolution (LTE)), Plain Old Telephone (POTS) networks, and wireless data networks (e.g., Institute of Electrical and Electronics Engineers (IEEE) 802 family of standards including IEEE 802.11 standards (Wi-Fi®), IEEE 802.16 standards (WiMaxt) and others), peer-to-peer (P2P) networks, or other protocols now known or later developed.

For example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

The behavior of the devices when running certain computation intensive workload is improved. Execution based on run time dynamics, such as network condition, available server resources, etc. is intelligently distributed. Mobile devices gather run-time information and user preference to make intelligent decision on the computing distribution. Multiple aspects of impacting factors are processed and optimal decision for performance, energy and cost are made collectively. Thus, the energy, performance and user experience is also significantly improved.

### ADDITIONAL NOTES EXAMPLES

Example 1 includes subject matter (such as a device, apparatus or architecture for providing cloud aware computing distribution, comprising a network conditions monitor for observing and for identifying decision impact factors of tasks in a runtime environment, a dynamic profiler, coupled to the network conditions monitor, for receiving runtime information regarding the decision impact factors identified by the network conditions monitor and for producing a profile based on the decision impact factors, runtime offload decision making logic, coupled to the dynamic profiler, for processing the profile produced by the dynamic profiler based on the received decision impact factors according a predetermined policy and determining final offloading decisions based on the predetermined policy and the processed decision impact factors, wherein the runtime offload decision making logic is to provide the final offloading decisions to the applications on the device for executing the tasks locally or remotely based on the determined final offloading decision.

Example 2 may optionally include the subject matter of Example 1, wherein the dynamic profiler is to convert the received decision impact factors to parameters used as input to runtime offload decision making logic.

Example 3 may optionally include the subject matter of any one or more of Examples 1 and 2, wherein the dynamic profiler is to continuously monitor and collect comprehensive runtime information to produce a profile and the runtime offload decision making logic is to make optimal offloading decision based on multiple considerations associated with the profile.

Example 4 may optionally include the subject matter of any one or more of Examples 1-3, wherein the network conditions monitor is to observe network availability and channel conditions and identify energy impact factors, performance impact factors, user preference impact factors and cost impact factors.

Example 5 may optionally include the subject matter of any one or more of Examples 1-4, wherein the runtime offload decision making logic is to consider a subset of the decision impact factors provided in the profile according to the predetermined policy.

Example 6 may optionally include the subject matter of any one or more of Examples 1-5, wherein the decision impact factors are associated with network availability and channel conditions.

Example 7 may optionally include the subject matter of any one or more of Examples 1-6, wherein the architecture further includes a client interface for communicating with a server interface at the remote cloud server to offload a task by moving the execution of the task from the local device to the remote server.

Example 8 may optionally include the subject matter of any one or more of Examples 1-7, wherein the runtime offload decision making logic is disposed at the mobile device.

Example 9 may optionally include the subject matter of any one or more of Examples 1-8, wherein the runtime offload decision making logic is disposed at the remote cloud server.

Example 10 may optionally include the subject matter of any one or more of Examples 1-9, wherein the dynamic profiler is to process the runtime information by determining a cost and a benefit of executing tasks locally and at a remote cloud server.

Example 11 may include, or may optionally be combined with the subject matter of any one or more of Examples 1-10 to include, subject matter (such as a method or means for performing acts) including starting an application, obtaining an action for the application preferred by a user, determining whether the user prefers local execution, gathering runtime information for a task when the user is determined to prefers remote execution, obtaining the preferred policy and a decided weight on the runtime information based on the preferred policy, calculating a final combination of weights for the runtime information and executing the offloading of the task based on the calculated final combination of weights for the runtime information.

Example 12 may optionally be combined with the subject matter of any one or more of Examples 1-11 to include, wherein the runtime information comprises energy impact factors, performance impact factors, user preference impact factors and cost impact factors.

Example 13 may optionally be combined with the subject matter of any one or more of Examples 1-12 to include, executing the process locally when the user is determined to prefer local execution.

Example 14 may optionally be combined with the subject matter of any one or more of Examples 1-13 to include, continuously monitoring and collecting comprehensive runtime information to produce a profile and making an optimal offloading decision based on multiple considerations associated with the profile.

Example 15 may optionally be combined with the subject matter of any one or more of Examples 1-14 to include, wherein the gathering runtime information comprises observing network availability and channel conditions.

Example 16 may optionally be combined with the subject matter of any one or more of Examples 1-15 to include, wherein the executing the offloading of the task figther comprises considering only a subset of the runtime information according to the preferred policy.

Example 17 may optionally be combined with the subject matter of any one or more of Examples 1-16 to include, wherein the calculating a final combination of weights for the runtime information comprises determining a cost and a benefit of executing tasks locally and at a remote cloud server.

Example 18 may include, or may optionally be combined with the subject matter of any one or more of Examples 1-17 to include, subject matter (such as means for performing acts or machine readable medium including instructions that, when executed by the machine, cause the machine to perform acts) including starting an application, obtaining an action for the application preferred by a user, determining whether the user prefers local execution, gathering runtime information for a task when the user is determined to prefer remote execution, obtaining the preferred policy and a decided weight on the runtime information based on the preferred policy, calculating a final combination of weights for the runtime information and executing the offloading of the task based on the calculated final combination of weights for the runtime information.

Example 19 may optionally be combined with the subject matter of any one or more of Examples 1-18 to include, wherein the runtime information comprises energy impact factors, performance impact factors, user preference impact factors and cost impact factors.

Example 20 may optionally be combined with the subject matter of any one or more of Examples 1-19 to include, executing the process locally when the user is determined to prefer local execution.

Example 21 may optionally be combined with the subject matter of any one or more of Examples 1-20 to include, continuously monitoring and collecting comprehensive runtime information to produce a profile and making an optimal offloading decision based on multiple considerations associated with the profile.

Example 22 may optionally be combined with the subject matter of any one or more of Examples 1-21 to include, wherein the gathering runtime information comprises observing network availability and channel conditions.

Example 23 may optionally be combined with the subject matter of any one or more of Examples 1-22 to include, wherein the executing the offloading of the task further comprises considering only a subset of the runtime information according to the preferred policy.

Example 24 may optionally be combined with the subject matter of any one or more of Examples 1-23 to include, wherein the calculating a final combination of weights for the runtime information comprises determining a cost and a benefit of executing tasks locally and at a remote cloud server.

Example 25 may include, or may optionally be combined with the subject matter of any one or more of Examples 1-24 to include, subject matter (such a system for providing cloud aware computing distribution) including a mobile device coupled to a server through a network, wherein the mobile device comprises a network conditions monitor for observing and for identifying decision impact factors of tasks in a runtime environment, a dynamic profiler, coupled to the network conditions monitor, for receiving runtime information regarding the decision impact factors identified by the network conditions monitor and for producing a profile based on the decision impact factors, runtime offload decision making logic, coupled to the dynamic profiler, thr processing the profile produced by the dynamic profiler based on the received decision impact factors according a predetermined policy and determining final offloading decisions based on the predetermined policy and the processed decision impact factors, wherein the runtime offload decision making logic is to provide the final offloading decisions to the applications on the device for executing the tasks locally at the mobile device or remotely at the server based on the determined final offloading decision, and wherein the server comprises at least one application for executing the at least one task offloaded from the mobile device and a server interface for processing data associated with the at least one task communicated between the mobile device and the server.

Example 26 may optionally be combined with the subject matter of any one or more of Examples 1-25 to include, wherein the dynamic profiler is further to continuously monitor and collect comprehensive runtime information to produce a profile and to convert the received decision impact factors to parameters used as input to the runtime offload decision making logic, the dynamic profiler is to further process the runtime information by determining a cost and a benefit of executing tasks locally and at a remote cloud server, the dynamic profiler.

Example 27 may optionally be combined with the subject matter of any one or more of Examples 1-26 to include, wherein the runtime offload decision making logic is to further make optimal offloading decision based on multiple considerations associated with the profile including considering a subset of the decision impact factors provided in the profile according to the predetermined policy.

Example 28 may optionally be combined with the subject matter of any one or more of Examples 1-27 to include, wherein the network conditions monitor is to observe network availability and channel conditions and to identify energy impact factors, performance impact factors, user preference impact factors and cost impact factors.

Example 29 may optionally be combined with the subject matter of any one or more of Examples 1-28 to include, wherein the decision impact factors are associated with network availability and channel conditions.

Example 30 may optionally be corribined with the subject matter of any one or more of Examples 1-28 to include, wherein the architecture further includes a client interface for communicating with a server interface at the remote cloud server to offload a task by moving the execution of the task from the local device to the remote server.

The above detailed description includes references to the accompanying drawings, which form a part of the detailed description. The drawings show, by way of illustration, specific embodiments may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more,” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure, for example, to comply with 37 C.F.R. §1.72(b) in the United States of America. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments may be determined with reference to the appended claims, along with the full scope of equivalents to which such claims are entitled.

What is claimed is:

1. A mobile device, comprising:
a network conditions monitor for observing and for identifying decision impact factors of tasks in a runtime environment;
a dynamic profiler, coupled to the network conditions monitor, for receiving runtime information regarding the decision impact factors identified by the network conditions monitor and for producing a profile based on the decision impact factors;
runtime offload decision making logic, coupled to the dynamic profiler, for processing the profile produced by the dynamic profiler based on the received decision impact factors according a predetermined policy and determining final offloading decisions based on the predetermined policy and the processed decision impact factors;
wherein the runtime offload decision making logic is to provide the final offloading decisions to the applications on the device for executing the tasks locally or remotely based on the determined final offloading decision.

2. The device of claim 1, wherein the dynamic profiler is to convert the received decision impact factors to parameters used as input to runtime offload decision making logic.

3. The device of claim 1, wherein the dynamic profiler is to continuously monitor and collect comprehensive runtime information to produce a profile and the runtime offload decision making logic is to make optimal offloading decision based on multiple considerations associated with the profile.

4. The device of claim 1, wherein the network conditions monitor is to observe network availability and channel conditions and to identify energy impact factors, performance impact factors, user preference impact factors and cost impact factors.

5. The device of claim 1, wherein the runtime offload decision making logic is to consider a subset of the decision impact factors provided in the profile according to the predetermined policy.

6. The device of claim 1, wherein the decision impact factors are associated with network availability and channel conditions.

7. The device of claim 1, wherein the architecture further includes a client interface for communicating with a server interface at the remote cloud server to offload a task by moving the execution of the task from the local device to the remote server.

8. The device of claim 1, wherein the runtime offload decision making logic is disposed at the mobile device.

9. The device of claim 1, wherein the runtime offload decision making logic is disposed at the remote cloud server.

10. The device of claim 1, wherein the dynamic profiler is to process the runtime information by determining a cost and a benefit of executing tasks locally and at a remote cloud server.

11. A method for providing intelligent cloud aware computing distribution, comprising:
starting an application;
obtaining an action for the application preferred by a user;
determining whether the user prefers local execution;
gathering runtime information for a task when the user is determined to prefer remote execution;
obtaining the preferred policy and a decided weight on the runtime information based on the preferred policy;
calculating a final combination of weights for the runtime information; and
executing the offloading of the task based on the calculated final combination of weights for the runtime information.

12. The method of claim 11, wherein the runtime information comprises energy impact factors, performance impact factors, user preference impact factors and cost impact factors.

13. The method of claim 11 further comprising executing the process locally when the user is determined to prefer local execution.

14. The method of claim 11 further comprising continuously monitoring and collecting comprehensive runtime information to produce a profile and making an optimal offloading decision based on multiple considerations associated with the profile.

15. The method of claim 11, wherein the gathering runtime information comprises observing network availability and channel conditions.

16. The method of claim 11, wherein the executing the offloading of the task further comprises considering only a subset of the runtime information according to the preferred policy.

17. The method of claim 11, wherein the calculating a final combination of weights for the runtime information comprises determining a cost and a benefit of executing tasks locally and at a remote cloud server.

18. At least one machine readable storage medium comprising instructions that, when executed by the machine, cause the machine to perform operations for intelligent cloud aware computing distribution, the operations comprising:
starting an application;
obtaining an action for the application preferred by a user;
determining whether the user prefers local execution;
gathering runtime information for a task when the user is determined to prefer remote execution;
obtaining the preferred policy and a decided weight on the runtime information based on the preferred policy;
calculating a final combination of weights for the runtime information; and
executing the offloading of the task based on the calculated final combination of weights for the runtime information.

19. The machine readable medium of claim 18, wherein the runtime information comprises energy impact factors, performance impact factors, user preference impact factors and cost impact factors.

20. The machine readable medium of claim 18 further comprising executing the process locally when the user is determined to prefer local execution.

21. The machine readable medium of claim 18 further comprising continuously monitoring and collecting comprehensive runtime information to produce a profile and making an optimal offloading decision based on multiple considerations associated with the profile.

22. The machine readable medium of claim 18, wherein the gathering runtime information comprises Observing network availability and channel conditions.

23. The machine readable medium of claim 18, wherein the executing the offloading of the task further comprises considering only a subset of the runtime information according to the preferred policy.

24. The machine readable medium of claim 18, wherein the calculating a final combination of weights for the runtime information comprises determining a cost and a benefit of executing tasks locally and at a remote cloud server.

25. A system for providing cloud aware computing distribution to improve performance and energy for mobile devices, comprising:
a mobile device coupled to a server through a network,
wherein the mobile device comprises:
a network conditions monitor for observing and for identifying decision impact factors of tasks in a runtime environment;
a dynamic profiler, coupled to the network conditions monitor, for receiving runtime information regarding the decision impact factors identified by the network conditions monitor and for producing a profile based on the decision impact factors;
runtime offload decision making logic, coupled to the dynamic profiler, for processing the profile produced by the dynamic profiler based on the received decision impact factors according a predetermined policy and determining final offloading decisions based on the predetermined policy and the processed decision impact factors;
wherein the runtime offload decision making logic is to provide the final offloading decisions to the applications on the device for executing the tasks locally at the mobile device or remotely at the server based on the determined final offloading decision; and
wherein the server comprises:
at least one application for executing the at least one task offloaded from the mobile device; and
a server interface for processing data associated with the at least one task communicated between the mobile device and the server.

26. The system of claim 25, wherein the dynamic profiler is further to continuously monitor and collect comprehensive runtime information to produce a profile and to convert the received decision impact factors to parameters used as input to the runtime offload decision making logic, the dynamic profiler is to further process the runtime information by determining a cost and a benefit of executing tasks locally and at a remote cloud server, the dynamic profiler.

27. The system of claim 25, wherein the runtime offload decision making logic is to further make optimal offloading decision based on multiple considerations associated with the profile including considering a subset of the decision impact factors provided in the profile according to the predetermined policy.

28. The system of claim 25, wherein the network conditions monitor is to observe network availability and channel conditions and to identify energy impact factors, performance impact factors, user preference impact factors and cost impact factors.

29. The system of claim 25, wherein the decision impact factors are associated with network availability and channel conditions.

30. The system of claim 25, wherein the architecture further includes a client interface tier communicating with a server interface at the remote cloud server to offload a task by moving the execution of the task from the local device to the remote server.
